(19) United States
(12) Patent Application Publication
(10) Pub. No.: US 2024/0161015 A1
(43) Pub. Date: May 16, 2024

(54) RANKING MACHINE LEARNING PIPELINES USING JOINT COMPUTATIONS

(71) Applicant: INTERNATIONAL BUSINESS MACHINES CORPORATION

(72) Inventors: Dhavalkumar C. Patel, White Plains, NY (US); Srideepika Jayaraman, White Plains, NY (US); Shuxin Lin, White Plains, NY (US); Anuradha Bhamidipaty, Yorktown Heights, NY (US); Jayant R. Kalagnanam, Briarcliff Manor, NY (US)

(21) Appl. No.: 17/986,001

(22) Filed: Nov. 14, 2022

(51) Int. Cl. G06N 20/20; G06F 11/34

(52) U.S. Cl. CPC G06N 20/20; G06F 11/3495

(57) ABSTRACT

Systems and methods for optimizing and training machine learning (ML) models are provided. In embodiments, a computer implemented method includes: performing, by a processor set, a group execution of ML pipelines using a first subset of a training data set as input data for the ML pipelines, thereby generating a trained ML model for each of the ML pipelines, wherein data transformations that are common between the ML pipelines are implemented only once to generate an output, and the output is shared between the ML pipelines during the group execution of the ML pipelines; generating, by the processor set, performance metrics for each of the trained ML models based on validation data; ranking, by the processor set, the trained ML models based on the performance metrics, thereby generating a list of ranked ML models; and outputting, by the processor set, the list of ranked ML models to a user.

### BACKGROUND

Aspects of the present invention relate generally to machine learning (ML) models and, more particularly, to eliminating redundant and unnecessary computations in ML pipeline optimizations.

An ML pipeline is an interconnected and streamlined collection of computer operations (e.g., data processing tasks) that orchestrates the flow of data into, and the output from, an ML model. The result of executing an ML pipeline with training data is a trained ML model. In general, an ML pipeline is used to help automate ML workflows, and operates by enabling a sequence of data to be transformed and correlated together in an ML model that can be tested and evaluated to achieve an outcome. In general, a learning algorithm finds patterns in training data that maps input data attributes to a target (e.g., what is being predicted), and outputs an ML model that captures the patterns.

The type of pipeline used may vary depending on the type of data to be analyzed. Different types of data may include time series data, image data, and tabular data. For example, a deep learning pipeline may be preferred for image data, while an ML pipeline may be preferred for time series data. Various methods have been implemented to obtain an optimal machine learning model using an ML pipeline. In one example, a method for streamlining data processing replaces data transformation components of an ML pipeline with data transformation components having a lower computing cost.

### SUMMARY

In a first aspect of the invention, there is a computer-implemented method including: performing, by a processor set, a group execution of machine learning (ML) pipelines using a first subset of a training data set as input data for the ML pipelines, thereby generating a trained ML model for each of the ML pipelines, wherein data transformations that are common between the ML pipelines are implemented only once to generate an output, and the output is shared between the ML pipelines during the group execution of the ML pipelines; generating, by the processor set, performance metrics for each of the trained ML models based on validation data; ranking, by the processor set, the trained ML models based on the performance metrics, thereby generating a list of ranked ML models; and outputting, by the processor set, the list of ranked ML models to a user.

In another aspect of the invention, there is a computer program product including one or more computer readable storage media having program instructions collectively stored on the one or more computer readable storage media. The program instructions are executable to: allocate multiple asset-centric multivariate time series data sets into a training data set and a validation data set based on predetermined rules; perform a group execution of machine learning (ML) pipelines using a first subset of the training data set as input data for the ML pipelines, thereby generating a trained ML model for each of the ML pipelines, wherein data transformations that are common between the ML pipelines are implemented only once to generate an output, and the output is shared between the ML pipelines during the group execution of the ML pipelines; generate performance metrics for each of the trained ML models based on the validation data; rank the trained ML models based on the performance metrics, thereby generating a list of ranked ML models; and output the list of ranked ML models to a user.

In another aspect of the invention, there is system including a processor set, one or more computer readable storage media, and program instructions collectively stored on the one or more computer readable storage media. The program instructions are executable to: allocate multiple asset-centric multivariate time series data sets into a training data set and a validation data set based on predetermined rules; perform a group execution of machine learning (ML) pipelines using a first subset of the training data set as input data for the ML pipelines, thereby generating a trained ML model for each of the ML pipelines, wherein data transformations that are common between the ML pipelines are implemented only once to generate an output, and the output is shared between the ML pipelines during the group execution of the ML pipelines; generate performance metrics for each of the trained ML models based on the validation data; rank the trained ML models based on the performance metrics, thereby generating a list of ranked ML models; and output the list of ranked ML models to a user.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the invention.

FIG. 3 depicts an exemplary machine learning (ML) pipeline in accordance with aspects of the invention.

FIG. 4 depicts a system overview in accordance with aspects of the invention.

FIG. 5 shows a flowchart of an exemplary method in accordance with aspects of the invention.

FIGS. 6A-6F depict comparisons of ML model training runtimes using an existing ML pipeline training method versus a method in accordance with aspects of the invention.

FIG. 7 is an illustrative example of ML pipeline rankings in accordance with aspects of the invention.

FIG. 8 is an exemplary graph depicting receiver operating characteristic (ROC) curves indicating the performance of ML pipelines with respect to number of assets utilized.

### DETAILED DESCRIPTION

Aspects of the present invention relate generally to machine learning (ML) models and, more particularly, to eliminating redundant and unnecessary computations in ML pipeline optimization. In embodiments, a method for jointly optimizing multi-data pipelines selects top performing pipelines by iteratively evaluating each pipeline in an asset and failure-centric data allocation schema. In implementations, a system takes as inputs: multiple data sets, a library of transformers, a library of estimators, and a library of ML pipelines, wherein the libraries of transformers, estimators and ML pipelines comprises a fixed set of transformers, estimators and ML pipelines initiated with some default parameters. In implementations, the system produces as an output: top performing ML pipelines and intermediate ML pipeline evaluations scores (rankings). Aspects of the invention utilize a data allocation schema to allocate training data in an incremental fashion using asset and failure-centric information. In embodiments, the system produces the ML pipeline evaluation scores after each iteration of the data allocation. In implementations, the system detects a saturation point indicating an amount of training data beyond which no meaningful improvement in an ML model is obtained.

ML pipelines are important components in an automated ML framework. However, finding a top-performing ML pipeline is a challenging task due to: large training data sets and large numbers of candidate pipelines. Initial model performance is poor for many ML pipelines. In general, as more training data (e.g., asset data) is provided to an ML pipeline, there is an increase in model performance. However, model performance often saturates (plateaus) as more training data is provided to the ML pipeline. These attributes of ML pipelines may lead to the use of large data sets (assets) to train and build ML models.

One tool used to automate the evaluation of ML pipelines is based on their performance on a relatively small data set of tabular data via a mechanism for incremental allocation of data. However, such a tool is not directly applicable to asset-centric multivariate time series data due to: assets varying in characteristics (e.g., a small pump versus a large pump), which prohibits random partitioning of the data; assets typically having different failure rates, which should be considered in the ML model training process; time series data being sequential, which prohibits randomized ordering of the data at issue; and time series data evolving over time, such that increasing the amount of training data does not always improve ML model performance.

Advantageously, embodiments of the invention may be utilized with large data sets of asset-centric multivariate time series data. Embodiments of the invention enable joint optimization of multi-data ML pipelines (e.g., pipelines receiving data from multiple tables), while considering the assets and time series nature of the input data (training data). Due to the complex nature of multi-asset, multi-variate time series data sets, which cannot be randomized, embodiments of the invention prepare training and testing data, and allocate the training and testing data in a joint optimization process to determine an optimal ML pipeline to generate the most accurate ML model. In aspects, due to repeated evaluation of multiple ML pipelines, a system automatically identifies common components (e.g., data transformations at transformers) across multiple ML pipelines in each of a plurality of ML model training rounds, and executes the common components only one time during each round to improve performance of the evaluation. In embodiments, a system allocates data in an asset-centric way and marks the threshold when ML model performance saturates (e.g., when there is no additional meaningful improvement in performance).

One exemplary ML pipeline of the invention includes first and second transformers and an estimator. In this example, the first transformer is configured to perform windowing, the second transformer is an imputer, and the estimator utilizes a gradient boosted trees algorithm to predict a target variable by combining an ensemble of estimates from a set of simpler and weaker models, such as eXtreme Gradient Boosting (XGBoost), which is an open-source implementation of the gradient boosted trees algorithm. Windowing refers to a flow control mechanism to manage the amount of transmitted data sent without receiving an acknowledgment. An imputer refers to a data processing tool that is used to fill in missing values by inferring from known values in a data set. Other data transformers may be utilized in the present invention, such as label generation and principal component analysis (PCA), and the invention is not intended to be limited to the examples discussed herein.

Implementations of the invention address the technical problem of computational costs associated with ML pipeline optimization by providing an automated system to explore multiple ML pipelines with common components, wherein computations for the common components are shared among the ML pipelines to improve performance and reduce resource usage. Advantageously, embodiments of the invention improve automated ML pipeline computing systems by determining an optimal ML pipeline to obtain a most accurate predictive ML model while eliminating duplicative computations, thereby reducing computational costs of the computing system and reducing ML pipeline testing runtimes. Implementations of the invention constitute improvements to ML methods that are firmly rooted in computer technology and address the technical problem of high processing costs associated with generating accurate ML predictive models.

In one embodiment, a computer program product is provided for determining an optimal ML pipeline for analyzing a system based on multiple asset-centric multivariate time series data sets, wherein the computer program product comprises a computer readable storage medium having program instructions embodied therewith. In implementations, the program instructions are executable by a processor to cause the processor to: receive a set of multi-data machine learning (ML) pipeline definitions, wherein each ML pipeline is defined as one or more transformers and estimators operating on a unique combination of one or more of the as set-centric multivariate time series data sets; allocate the data sets into a training data set and a testing (validation) data set in an incremental fashion using asset-centric information; use the training data set to perform ML training of each ML pipeline to create an ML model for each ML pipeline, wherein transformation components that are common between ML pipelines are executed only once and are shared between ML pipelines; apply each pipeline ML model to the testing data; evaluate the accuracy of the each pipeline ML model; rank the ML pipelines based on the accuracy of the pipeline ML model; and select the optimized multi-data ML pipeline as the top ranked ML pipeline.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as Optimizing and Training ML Models 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

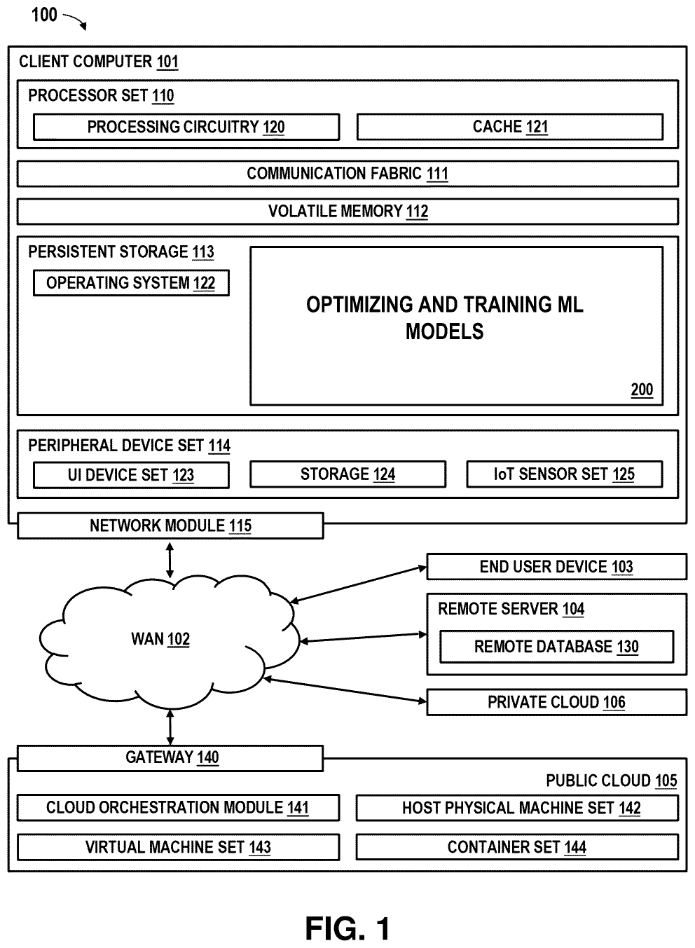

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

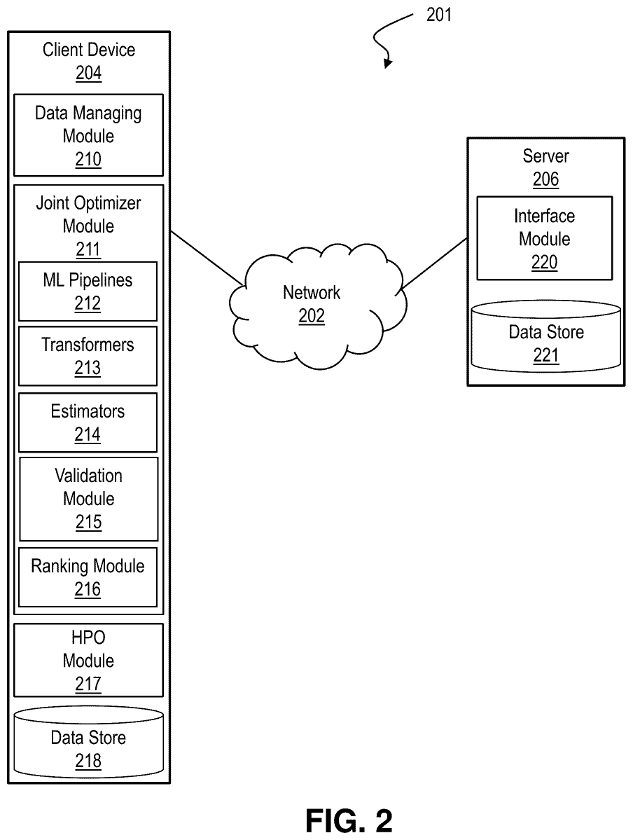

FIG. 2 shows a block diagram of an exemplary environment 201 in accordance with aspects of the invention. In the example of FIG. 2, a network 202 enables communication between a client device 204 and a server 206. The network 202 may be the WAN 102 of FIG. 1. In embodiments, the client device 204 of FIG. 2 comprises the client computer 101 of FIG. 1, or elements thereof. The server 206 may comprise an instance of the remote server 104 of FIG. 1, or elements thereof.

In embodiments, the client device 204 comprises software code (e.g., block 200 of FIG. 1) including one or more modules. In implementations, modules of the code of block 200 are executable by the processing circuitry 120 of FIG. 1 to perform the inventive methods as described herein. In the example of FIG. 2, the client device 204 includes a data managing module 210 for managing data of interest (e.g., tables of data), and a joint optimizer module 211 for implementing iterative ML pipeline analysis and execution in accordance with embodiments of the invention based on a library of ML pipelines 212, a library of transformers 213 and a library of estimators 214.

In aspects of the invention, the client device 204 is configured to iteratively execute a plurality of preconfigured ML pipelines using allocations of input training data (training data sets) to generate ML models whose performance is evaluated at each iteration. Based on the performance of the ML models, the client device 204 may modify a next iteration to execute a subset of the preconfigured ML pipelines using a subset of the training data while eliminating duplicative ML pipeline computations to obtain an optimized ML pipeline that generates an accurate predictive ML model.

In implementations, a validation module 215 of the joint optimizer module 211 is configured to evaluate the performance (e.g., accuracy) of ML models generated from executing ML pipelines, and a ranking module 216 of the joint optimizer module 211 is configured to rank or score individual ML pipelines based on the performance evaluation. In embodiments, a hyperparameter optimization (HPO) module 217 is configured to determine the best data assets (hyperparameters) in the training data for training the ML model(s). The client device 204 may obtain sets of data from a local source, such as data store 218, or may obtain sets of data from one or more remote sources, such as server 206. By way of example, the data managing module 210 of FIG. 2 may communicate with the interface module 220 of the server 206 to obtain one or more data tables from the data store 221 of the server 206.

The client device 204 and the server 206 may each include additional or fewer modules than those shown in FIG. 2. In embodiments, separate modules may be integrated into a single module. Additionally, or alternatively, a single module may be implemented as multiple modules. Moreover, the quantity of devices and/or networks in the environment 201 is not limited to what is shown in FIG. 2. In practice, the environment 201 may include additional devices and/or networks; fewer devices and/or networks; different devices and/or networks; or differently arranged devices and/or networks than illustrated in FIG. 2.

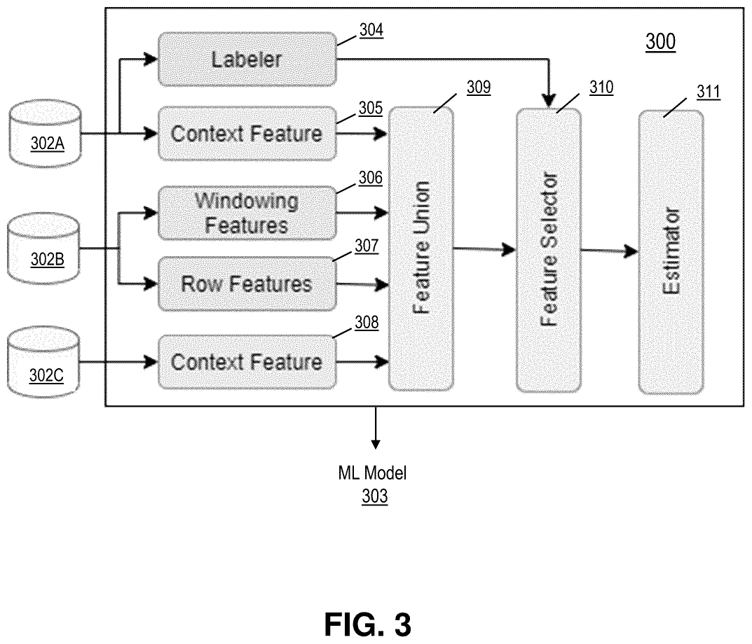

FIG. 3 depicts an exemplary machine learning (ML) pipeline 300 in accordance with aspects of the invention. In implementations, the ML pipeline 300 is a multi-data pipeline that obtains data from multiple separate tables of data, represented by tables 302A-302C, in order to generate an ML model 303 as an output. In one example, the ML pipeline 300 analyzes failure patterns, and returns a predictive ML model configured to predict failures. The tables 302A-302C may be divided into training data and validation data. The exemplary ML pipeline 300 includes multiple ML data transformers, including a labeler 304, a context feature component 305, a windowing feature component 306, a row features component 307, a context feature component 308, a feature union component 309, and a feature selector component 310. The exemplary ML pipeline 300 also includes an estimator 311. The term data transformer as used herein refers to an ML modeling tool that processes or pre-processes sequential training data to put the data in proper form for training an ML model. The term estimator as used herein refers to a computing tool for picking the best or most likely accurate data model based on training data. The term windowing as used herein refers to a flow control mechanism to manage the amount of transmitted data sent without receiving an acknowledgment. In ML and pattern recognition, the term feature refers to an individual measurable property or characteristic.

In implementations, the labeler 304 automatically assigns labels to training data based on predefined rules. In embodiments, the context feature component 305 automatically assigns a first set of contextual features to the training data, the windowing feature component 306 automatically assigns windowing features to the training data, the row features component 307 automatically assigns row features to the training data, and the context feature component 308 automatically assigns a second set of contextual features to the training data.

In the example of FIG. 3, the feature union component 309 is configured to combine outputs of transformers in parallel to generate one output matrix. In the example of FIG. 3, the feature union component 309 combines outputs from the parallel transformers including: the context feature component 305, the windowing feature component 306, the row features component 307 and the context feature component 308. In aspects, labeled training data from the labeler 304 and the data output from the feature union component 309 are input to the feature selector component 310, and the output from the feature selector component is input to the estimator 311. In aspects of the invention, the feature selector component 310 is configured to select the most important variables and eliminate redundant and irrelevant features based on predetermined rules, to increase the predictive power of the ML model 300 generated. In accordance with aspects of the invention, the estimator 311 generates the ML model 303 (predictive model). It should be understood that embodiments of the invention may utilize any type of ML data transformer, and the invention is not intended to be limited to the transformers listed herein.

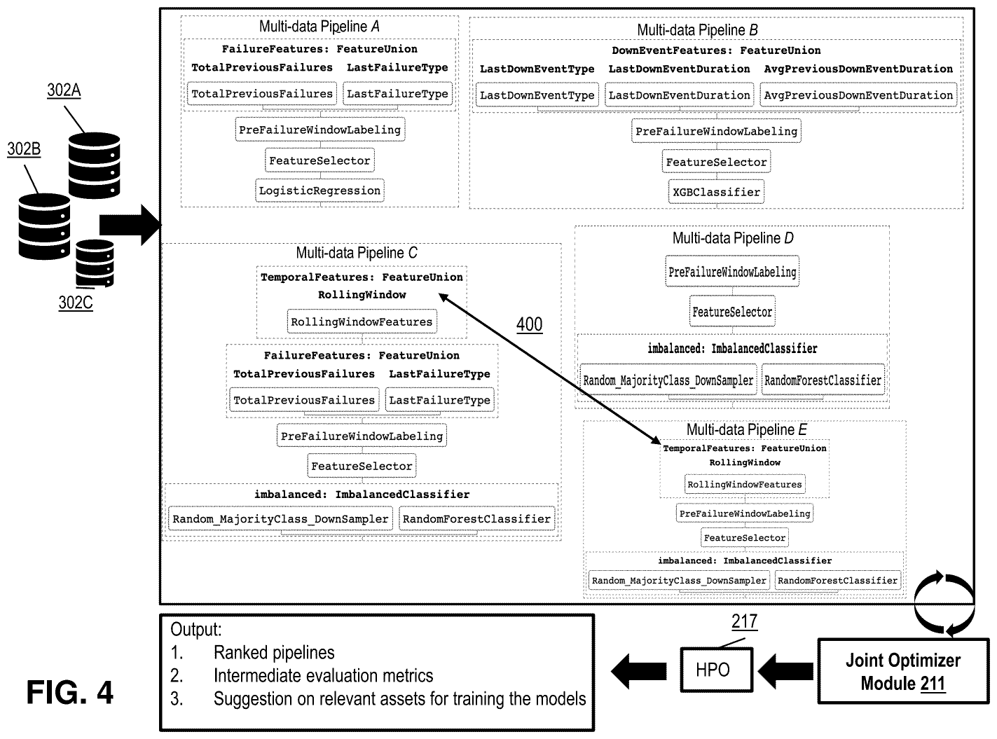

FIG. 4 depicts a system overview in accordance with aspects of the invention. Steps illustrated in FIG. 4 may be carried out in the environment 201 of FIG. 2 and are described with reference to elements depicted in FIGS. 2 and 3.

In the example of FIG. 4, a set of input data or training data includes data from multiple data tables 302A-302C. In one exemplary use scenario, the data tables 302A-302C comprise a table of sensor data, a table of failure data, and a table of downtime for oil pumps. In accordance with embodiments of the invention, the joint optimizer module 211 selects a minimum allocation (amount) of data (e.g., a minimum number of assets and/or failures) as input data for a plurality of ML pipelines represented by multi-data pipelines A-E. The minimum allocation of data may be based on predetermined rules and/or learned rules. In accordance with implementations of the invention, the joint optimizer module 211 inputs the minimum allocation training data into each of the multi-data pipelines A-E and executes the multi-data pipelines A-E to generate respective ML model outputs.

During execution of the multi-data pipelines A-E, the joint optimizer module 211 determines duplicative computations among two or more of the multi-data pipelines A-E, and consolidates the duplicative computations into a single computation, the results of which are shared between the two or more multi-data pipelines A-E, thereby reducing processing costs associated with executing the group of multi-data pipelines A-E. One example of a duplicative computation indicated at 400 is the use of a temporal feature tool and a feature union tool in both the multi-data pipeline C and the multi-data pipeline E.

In accordance with implementations of the invention, the joint optimizer module 211 evaluates the accuracy of ML models output from the multi-data pipelines A-E, and will continue to iteratively execute selected ones of the multi-data pipelines A-E based on the accuracy of the ML models generated using additional allocations of input (training) data until the accuracy of the ML model(s) generated show no meaningful performance improvement according to predetermined rules (e.g., until saturation of the ML model performance is detected). In aspects of the invention, the allocation of additional data for each iteration is based on assets of the input data and maintaining base failure rates of the multi-data pipelines A-E or subsets thereof.

In implementations of the invention, the joint optimizer module 211 works with the hyperparameter optimization (HPO) module 217 to determine the best assets for training the ML model(s). The term HPO as used herein refers to the problem of choosing a set of optimal hyperparameters for a learning algorithm. The term hyperparameter refers to a parameter whose value is used to control the learning process in machine learning. In general, hyperparameter optimization finds a tuple of hyperparameters that yields an optimal ML model which minimizes a predefined loss function on given independent data.

In accordance with aspects of the invention, for each iteration of the execution of the multi-data pipelines A-E or a subset thereof, the joint optimizer module 211 outputs a ranking of the executed multi-data pipelines A-E or the subset thereof (e.g., most accurate to least accurate), intermediate evaluation metrics (e.g., performance metrics) for each of the executed multi-data pipelines A-E or the subset thereof, and suggestions on relevant assets (hyperparameters) for training the ML models.

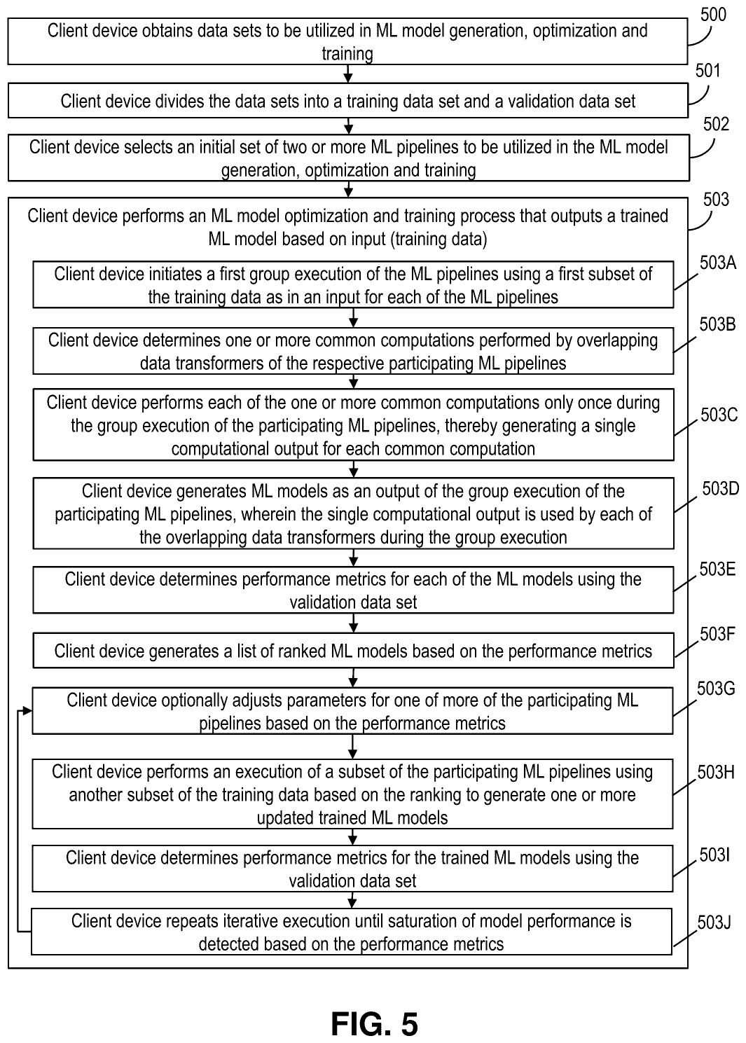

FIG. 5 shows a flowchart of an exemplary method of optimizing and training ML models in accordance with aspects of the invention. Steps of the method may be carried out in the environment of FIG. 2 and are described with reference to elements depicted in FIGS. 2 and 3.

At step 500, the client device 204 obtains one or more data sets to be utilized in generating, optimizing and training an ML model (ML model 300). The data sets may be obtained from a local data store (e.g., data store 218), or may be obtained from one or more remote sources (e.g., data store 221 of server 206). In aspects of the invention, the one or more data sets are in the form of separate data tables. In embodiments, the one or more data sets comprise multiple asset-centric multivariate time series data sets. Time series data is sequential, and cannot be randomized without destroying information imparted by the time series data. Similarly, assets vary in characteristics, such that asset-centric data cannot be partitioned randomly without destroying information imparted by the asset-centric data. The term asset, as used herein, refers to a data set of a particular category type associated with a particular problem to be solved (e.g., a particular prediction). An asset may be defined by a particular column name in a data table. By way of example, an asset may be an oil well that is identified in a column of a data table, and an ML model to be generated/trained may predict certain future events at the oil well. In embodiments, the data managing module 210 of the client device 204 implements step 500.

At step 501, the client device 204 divides the one or more data sets into a training data set utilized to generate and train ML models (e.g., ML model 303) via select ML pipelines (e.g., multi-data pipelines A-E), and a validating data set utilized to determine performance metrics (e.g., accuracy) for the ML models. In embodiments, the one or more data sets are divided based on predetermined stored rules. In one example, a data set contains 100 assets, and the client device 204 divides the 100 assets into 80 training assets and 20 validation assets based on stored rules. Subsets of training data may be utilized in incremental training of ML pipeline models in accordance with implementations of the invention. By way of example, out of 80 training assets, the client device 204 may select a predetermined percentage (e.g., 30%) for an initial subset of training data, and may select 10% of the training assets for each subsequent subset of training data. Based on performance of the ML models after a first training session, the client device 204 may eliminate unsuccessful ML models based on performance, and perform a second training session with additional subsets of the training assets, and so on, until training of an ML model is determined to be complete. Additional details of the ML model optimization and training sessions are described below. In embodiments, the data managing module 210 of the client device 204 implements step 501.

It can be understood that there are many ways to split data of interest into training and validation (testing) splits or subsets. Data may be split in an asset-centric way, a time series way, or a failure+asset way, for example. In an asset-centric split, data is divided by assets (e.g., table columns). By way of example, a set of data may be divided such that 70% of assets are used in training and 30% of assets are used in validation. One drawback to this method is that some assets may be more prone to failure than others. Thus, an asset-centric split may result in more class imbalance in one subset (split) of data.

In a time series split, a first timestamp in the data of interest (e.g., 70^{th} percentile) marks a cutoff for training data, and data after that cutoff is used as validation data. However, it is common for assets to fail more towards a latter end of their life span. Thus, a 70^{th} percentile cutoff in time may result in more failures in the testing data.

In a failure+asset-centric split, the client device 204 considers the data in a failure table, and finds a timestamp of the 70^{th} percent of failures (time sorted), and splits the training and validation data from all tables at that timestamp so that distribution failures are even in the training and validation data. In this case, data is always considered in an asset-centric way in an increasing allocation format. In one exemplary scenario, input data for ML pipelines is in the form of raw data from a sensor table, a failure table, and other tables. In this scenario, the client device 204 sorts data in the failure table time-series wise, wherein the data contains assets and their failures in each record. Given a split percentage (e.g., 70%), the client device 204 records the timestamp at that percentile of the failure table. The client device 204 then splits all tables based on this timestamp to contain 70% of failures in the training data and 30% of the failures in the validation data for each asset sample size. The client device 204 then outputs a split of the data at issue in the form of training data and validation data.

At step 502, the client device 204 selects an initial set of two or more ML pipelines (participating ML pipelines) to be utilized in an initial ML model generating and training session. In implementations, each of the two or more ML pipelines comprises a unique combination of transformers and estimators. In embodiments, the client device 204 selects from: a plurality of preconfigured ML pipeline models in the ML pipeline library 212, a selection of transformers for use in the ML pipeline models from the transformers library 213, and a selection of estimators for use in the ML pipeline models from the estimators library 214. In embodiments, one or more of the ML pipelines is in the form of a multi-data pipeline (e.g., ML pipeline 300) configured to train an ML model (e.g., ML model 303) using data obtained from multiple separate data tables (e.g., 302A-302C). In embodiments, the joint optimizer module 211 of the client device 204 implements step 502.

Empirically, it has been identified that some combinations of transformers work better on certain types of data than other transformers. In embodiments, the client device 204 recommends a subset of available ML pipelines (e.g., top performing ML pipelines) for a user to run for a particular type of data set based on stored rules. In implementations, the recommended ML pipelines are ML pipeline models including configuration parameters. In aspects of the invention, the client device 204 builds ML pipelines (e.g., the recommended ML pipelines) for the data set at issue based on types of input tables. In one example, ten (10) pipelines are built by the client device 204 utilizing the following strategy:

```
If down_event_table exists:
  add all down event features to pipeline_i
If failure table exists:
  add all failure features and labeling to pipeline_i
If class imbalance exists:
  add imbalanced classifier as estimator to pipeline_i.
```

In implementations of the invention, the above strategy is performed for all ML pipeline combinations to dynamically build ML pipelines based on the type of data available. Various tools may be utilized to generate ML pipeline combinations, and implementations of the invention are not intended to be limited to a particular tool. An example of eleven (11) ML pipelines P_1 through P_11 created using one such tool is set forth in the Table below. The Table depicts, for each ML pipeline, identifiers of available failure tables (i.e., TPF, TSLF, AF and LF), identifiers of available down tables (i.e., LDED, ADED, LD), and identifiers of available sensor tables (i.e., RW). In the example below, RW stands for RollingWindow, TPF stands for TotalPreviousFailure, LD stands for LastDown, AF stands for AvgFailurelntervals, TSLF stands for TimeSinceLastFailure, LDED stands for LastDownEventDuration, and ADED stands for AvgPreviousDownEventDuration. The Table also depicts an estimator type used by each of the ML pipelines.

TABLE
Exemplary Pre-Configured ML Pipelines

| | | | Sensor | |
|---|---|---|---|---|
| No. | Failure Table | Down Table | Table | Estimator |
| P_1 | TPF, TSLF, AF, | LDED, ADED, | RW | Imbalanced |
| | LF | LD | | |
| P_2 | TPF, TSLF, AF, | | RW | Imbalanced |
| | LF | | | |
| P_3 | | | RW | Logic |
| | | | | Regression |
| P_4 | | | RW | XGBoost |
| P_5 | TPF, TSLF, AF, | | | Logistic |
| | LF | | | Regression |
| P_6 | TPF, TSLF, AF, | | | XGBoost |
| | LF | | | |
| P_7 | | LDED, ADED, | | Logistic |
| | | LD | | Regression |
| P_8 | | LDED, ADED, | | XGBoost |
| | | LD | | |
| P_9 | TPF, TSLF, AF, | LDED, ADED, | | Imbalanced |
| | LF | LD | | |
| P_10 | | | RW | Imbalanced |
| P_11 | | | | Imbalanced |

At step 503, the client device 204 performs an ML model optimization and training process that outputs a trained ML model (an ML predictive model) based on input (training) data. In accordance with aspects of the invention, intermediate steps of each participating ML pipeline must implement fit and transform methods, and each participating ML pipeline is executed with fit parameters. In embodiments, the ML model optimization and training process utilizes joint computations of overlapping transformers of the selected ML pipelines during an execution of a group of selected ML pipelines. In implementations, the joint optimizer module 211 of the client device 204 receives a list of participating ML pipelines to be executed with fit parameters as an input, and the client device 204 visits the participating ML pipelines linearly, examines the steps of the participating ML pipelines, and stores each unique fit parameter/transformer pair. Once all steps from all participating ML pipelines are stored (except the estimator), the steps of the ML pipelines are executed and the result (e.g., the output of the transformers) is stored back in a dictionary. Once all transformers in a participating ML pipeline are executed, each ML pipeline appends the stored values of steps of the ML pipeline to the input data, and the client device 204 passes the appended input data to the estimator of the participating ML pipeline to fit. In implementations, the estimator (e.g., estimator 311 of FIG. 3) of the ML pipeline gets the entire data after all data transformations of the participating ML pipelines are performed. In aspects of the invention, the ML model optimization and training process includes the following substeps detailed below.

At substep 503A, the client device 204 initiates a group execution of the participating ML pipelines in a first ML model training session using a first subset of the training data set as input data for each of the participating ML pipelines. By way of example, the client device 204 may input 30% of the assets in the training data set as input data to each of ten (10) participating ML pipelines, wherein each of the ten ML pipelines comprises a different combination of transformers and estimators. In embodiments, substep 503A is implemented by the joint optimizer module 211 of the client device 204.

At substep 503B, the client device 204 determines one or more common computations performed by overlapping data transformers of the respective participating ML pipelines. For example, the client device 204 may determine that a first ML pipeline (e.g., multi-data pipeline C of FIG. 4) and a second ML pipeline (e.g., multi-data pipeline E of FIG. 4) both utilize a temporal feature component and feature union component (e.g., TemproalFeatures: FeatureUnion in FIG. 4) to transform data. In embodiments, substep 503B is implemented by the joint optimizer module 211 of the client device 204.

In implementations, most participating ML pipelines will have some overlapping or common component. Each component may be described by an identification (ID), a name, and an operation. In order to take advantage of these overlapping components, implementations of the invention execute each common component only once via the client device 204, thus performing transformations (not a fitting via an estimator) only once during the lifetime of participating ML pipeline executions, by checking the overlap in the form of training data as well as parameters. Some time consuming components (e.g., rolling window feature transformers) are thus executed only once during group execution of participating ML pipelines, eliminating process time and reducing the computational costs of the pipeline executions, as discussed below.

In embodiments of the invention, the client device 204 performs the following matching protocol. Initially, the client device 204 compares names of components in the participating ML pipelines to identify any common names between the respective ML pipelines, wherein components with the same name indicate possible common computations. The client device 204 then looks at the relative positions of each the possible common components within their respective ML pipelines to determine if the relative positions of the components within their respective ML pipelines are the same. For those possible common computations having the same relative positions within an ML pipeline, the client device 204 compares operation's parameters of the respective possible common computations to see if they match. Thus, in implementations, the client device 204 determines that components of different ML pipelines are common computations when their names, relative positions within an ML pipeline, and operations parameter's match.

At substep 503C, the client device 204 performs each of the one or more common computations only once during the group execution of the participating ML pipelines, thereby generating a single computational output for each of the one or more common computations, and eliminating duplicative computations that would otherwise be performed if each of the respective overlapping ML pipelines were executed separately. In embodiments, substep 503C is implemented by the joint optimizer module 211 of the client device 204.

At substep 503D, the client device 204 generates, as an output of the group execution of the participating ML pipelines, an initial ML model for each of the two or more ML pipelines, wherein the single computational output is used by each of the overlapping data transformers in the group execution of the participating ML pipelines. Using the multi-data pipelines of FIG. 4, for example, the multi-data pipeline A would generate a first ML model, the multi-data pipeline B would generate a second ML model, the multi-data pipeline C would generate a third ML model, and so on. In embodiments, substep 503D is implemented by the joint optimizer module 211 of the client device 204.

At substep 503E, the client device 204 determines performance metrics (e.g., errors, accuracy, etc.) for each of the ML models generated at substep 503D based on the validation data set. In implementations, the validation data set is a sample of data held back from training an ML model(s) that is used to obtain a measure of an ML models forecasting (prediction) accuracy. In implementations, the client device 204 validates the ML models based on the validation data set and determines a measure of accuracy of the ML models. In embodiments, the client device 204 utilizes the validation data set to test the accuracy of the ML models generated by each of the two or more ML pipelines at substep 503D. Various model validation tools may be utilized by the client device 204 at substep 503E, and the invention is not intended to be limited to any specific validation tools. In embodiments, substep 503E is implemented by the validation module 215 of the client device 204.

At substep 503F, the client device 204 generates a ranking of the participating ML pipelines based on the performance metrics determined at substep 503E. In implementations, the client device 204 presents the performance metrics, ranking, and/or suggestions to improve the ML model training to the user, via a graphical user interface (GUI). In embodiments, substep 503F is implemented by the ranking module 216 of the client device 204.

Optionally, at substep 503G, the client device 204 adjusts parameters of one or more of the participating ML pipelines based on the performance metrics. An ML model that results in a similar error distribution on an internal test data set even after allocating more data points (training data) suggests: (1) the ML model has already acquired the requisite learning, and additional training data would provide no additional benefits; (2) early decisions may be made to instruct the ML model to change some parameter if its performance is significantly poor; and (3) introduction of early feedback in competition may be beneficial by providing more chances to boost the performance of the ML pipeline which is performing poorly. In one exemplary early feedback scenario, an ML pipeline A has adjusted some parameter based on the data given in a first ML model training session (e.g., the parameter setting is not working well). In this case, an early feedback to the client device 204 provides an opportunity for the client device 204 to adjust the parameter before initiating additional ML model training sessions. For example, the client device 204 may adjust a parameter before performing five (5) additional training rounds with additional subsets of training data. Since internal test data does not change, the client device 204 is permitted to compare the effects of allocating more data points (training data) with respect to the errors that are generated in an ML model at issue. In embodiments, substep 503G is implemented by the HOP module 217 of the client device 204.

At substep 503H, the client device 204 performs an execution of a subset of the participating ML pipelines using another subset of the training data based on the ranking to generate one or more trained ML models. In implementations, the client device 204 selects one or more top rated participating ML models to execute at substep 503H based on the ranking of step 503F, wherein a trained ML model is generated for each of the selected ML models. In embodiments, substep 503H is implemented by the joint optimization module 211 of the client device 204. For example, the client device 204 may select the top rated participating ML pipeline to generate a single trained ML model.

In implementations, when the subset of participating ML pipelines includes multiple pipelines, the client device 204 also performs step 503B and 503C on the subset of ML pipelines, such that the execution of the subset of the participating ML pipelines generates ML models as an output of the group execution of the subset of the ML pipelines, wherein a single computational output is used by each overlapping data transformer during the group execution.

At substep 503I, the client device 204 determines performance metrics for the one or more trained ML models using the validation data set. Substep 503I may be implemented in the same manner as substep 503E, and may be implemented by the validation module 215 of the client device 204.

At substep 503J, the client device 204 repeats iterative execution of at least one of the participating ML pipelines until saturation of a trained ML model performance is detected based on the performance metrics. It should be understood that every iteration of substep 503H further trains the participating ML pipelines with additional subsets of training data. In embodiments, the client device 204 compares performance metrics of a trained ML model generated by an initial iteration of the substep 503H and the performance metrics of an updated trained ML model generated by the next subsequent iteration of the substep 503H to determine an amount of improvement in the accuracy of the trained ML model due to the additional training of the ML model. In implementations, when the client device 204 determines that the trained ML model performance (e.g., accuracy of predictions) will not be improved by additional training (based on predetermined threshold values), the client device 204 determines that the last trained ML model generated is the optimized ML model, and provides a report to a user with the last trained ML model, and/or performance metrics regarding the last trained ML model.

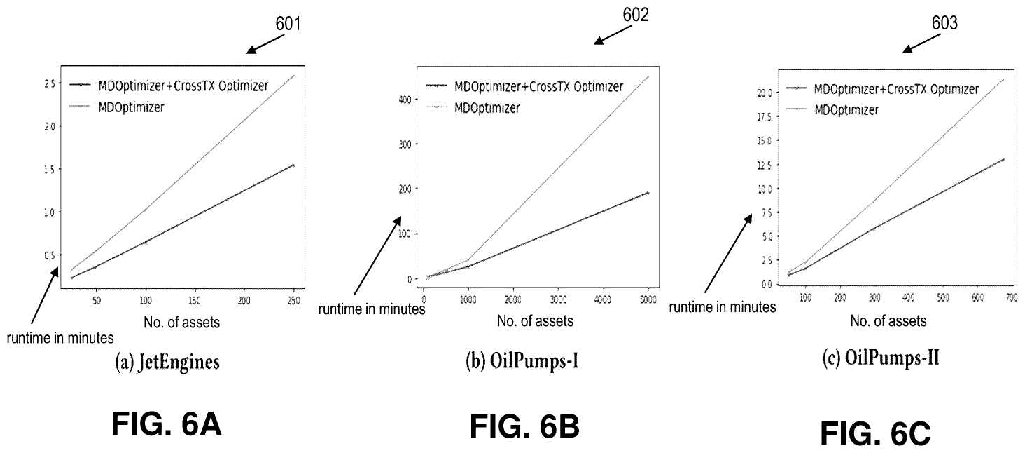

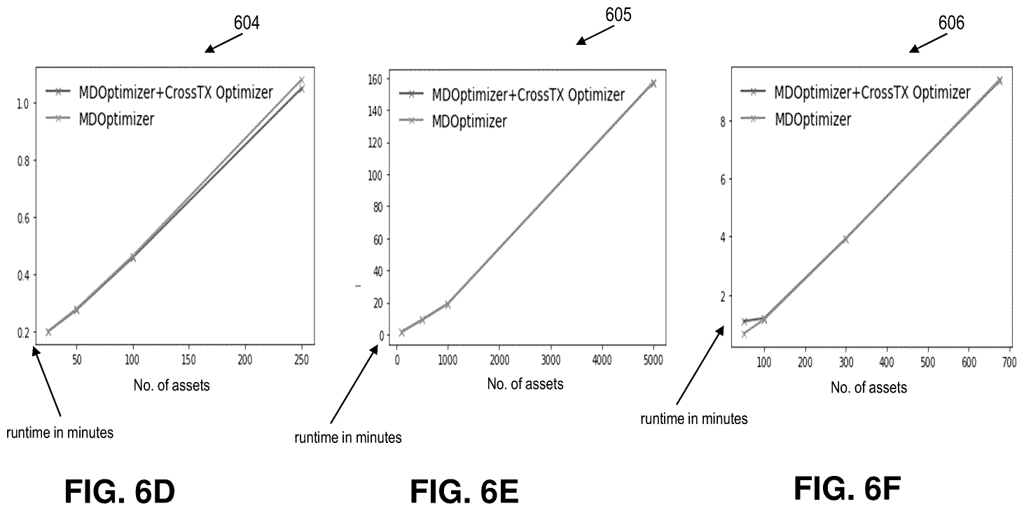

FIGS. 6A-6F depict comparisons of ML model training runtimes using an existing ML pipeline training method versus a method in accordance with aspects of the invention.

With initial reference to FIGS. 6A-6C, runtimes for three ML pipelines using existing methods (MDOptimizer) are compared to runtimes for the three ML pipelines run using a joint optimization method (MDOptimizer+CrossTX Optimizer) according to embodiments of the invention, wherein the ML pipelines included some common components (e.g., overlapping data transformers). By way of example, a data set related to jet engines was graphed in the FIG. 6A chart 601 entitled (a) JetEngines, a data set related to a first set of oil pumps was graphed in the FIG. 6B chart 602 entitled (b) OilPumps-I, and a data set related to a second set of oil pumps was graphed in the FIG. 6C chart 603 entitled (c) OilPumps-II. A first set of experiments was set up, for each data set, by sampling asset-splits of various sizes for training, and a default set of ten pipelines was executed in a sequential manner as well as through a joint optimizing method according to embodiments of the invention (including the shared execution of common/overlapping pipeline components). It can be seen that the joint optimizing method improved performance by about two fold when executing shared pipeline components only once (MDOptimizer+CrossTX Optimizer), as opposed to executing components of each pipeline separately (MDOptimizer). Thus, it can be understood that some ML transformers are time consuming, and implementations of the invention provide an advantage by eliminating the need to perform redundant computations.

With reference to FIGS. 6D-6F, runtimes for the three ML pipelines of FIGS. 6A-6C using existing methods (MDOptimizer) are compared to runtimes for the three ML pipelines run using a joint optimization method (MDOptimizer+CrossTX Optimizer) in charts 604-606 according to embodiments of the invention, wherein the ML pipelines did not include any common components. A second set of experiments was set up for the data sets using ten pipelines similar to the first set of experiments, but with no overlap of the pipeline components. More specifically, in the second set of experiments, each ML pipeline contained one transformer and one estimator, and all transformers were present only once. The data was sampled in an asset-centric manner, and on increasing assets, the runtime was recorded. It can be seen in charts 604-606 that there is no meaningful improvement in runtime between the pipelines executed in a sequential manner (MDOptimizer) and the pipelines executed using the joint optimization method according to embodiments of the invention when no overlapping transformers were present.

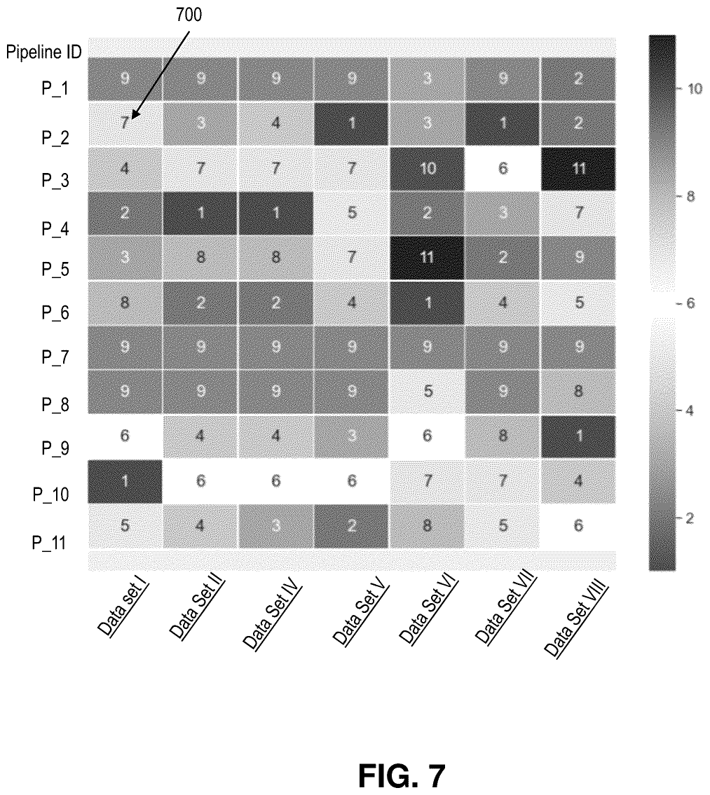

FIG. 7 is an illustrative example of ML pipeline rankings in accordance with aspects of the invention. In the example of FIG. 7, ten (10) overlapping preconfigured pipelines P_1 through P_10 were executed on data sets I through VIII utilizing the joint optimization method according to embodiments of the invention, and the numeric rankings on a scale of 1-10 (best to worst) were compared. See, for example, the numeric ranking 700 indicating that, for data set I, the pipeline P_2 has a numeric ranking of 7. Some pipelines, including P_2, P_4 and P_6 performed very well, indicating that the use of contextual features in a pipeline improves performance. Some pipelines with a compulsory down event table have bad rankings, since only two data sets contain a down event table. An imbalance classifier also plays a large role in the relative performance of the pipelines. In the example of FIG. 7, ML pipeline P_11 is considered as a baseline ML pipeline, and includes an imbalanced classifier with no feature generation. We see from this example that ML pipeline P_11 has average rankings, wherein it is never the best or worst, and some ML pipelines consistently perform better. In implementations, the client device 204 analyzes the ranked pipelines to derive performance metrics, and utilizes the performance metrics to choose one or more ML pipelines for further execution and/or to determine adjustments to be made at step 503G, or to be suggested to a user in a report.

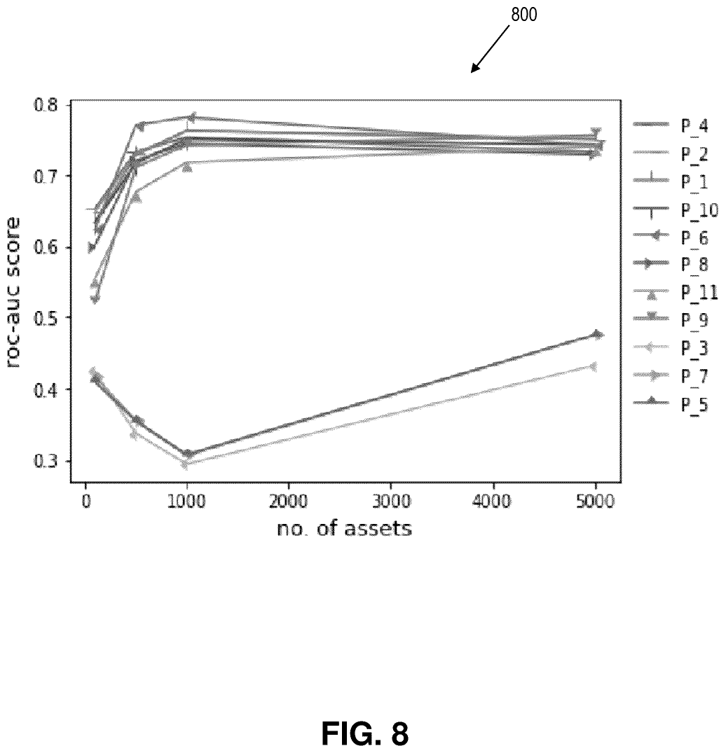

FIG. 8 is an exemplary graph 800 depicting receiver operating characteristic (ROC) curves indicating the performance of ML pipelines with respect to number of assets utilized. More specifically, FIG. 8 illustrates Area under the ROC curve (AUC) scores of test data for each step based on a data set for OilPumps-1. In general, a ROC curve shows the performance of a classification model at all classification thresholds. AUC measures the entire two-dimensional area underneath the entire ROC curve and provides an aggregate measure of performance across all possible classification thresholds. Analysis of the results indicates that a logistic regression classifier does not scale well with more data. That is, the logistic regression classifier initially provides good results that become worse with more data. Additionally, an imbalance classifier starts off with low results, but improves to become very powerful towards the end (with more data). The ROC curves saturates after 1000 assets, indicating that no additional parameters need to be input to the ML pipelines. That is, there is no meaningful improvement to the performance of the ML pipelines obtained by utilizing more than 1000 assets. In implementation, substep 506J utilizes a ROC curve to determine whether the model performance is saturated.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
performing, by a processor set, a group execution of machine learning (ML) pipelines using a first subset of a training data set as input data for the ML pipelines, thereby generating a trained ML model for each of the ML pipelines, wherein data transformations that are common between the ML pipelines are implemented only once to generate an output, and the output is shared between the ML pipelines during the group execution of the ML pipelines;
generating, by the processor set, performance metrics for each of the trained ML models based on validation data;
ranking, by the processor set, the trained ML models based on the performance metrics, thereby generating a list of ranked ML models; and
outputting, by the processor set, the list of ranked ML models to a user.

2. The method of claim 1, further comprising:
allocating, by the processor set, data into the training data set and a validation data set based on predetermined rules;
wherein the data comprises multiple asset-centric multivariate time series data sets; and
wherein the first subset of the training data set includes data from each of the multiple asset-centric multivariate time series data sets.

3. The method of claim 1, further comprising selecting, by the processor set, the ML pipelines from a store of available ML pipelines, wherein each of the ML pipelines includes a unique combination of one or more data transformers and an estimator.

4. The method of claim 1, wherein the group execution of the ML pipelines comprises:
determining, by the processor set, that the data transformations are common between the ML pipelines;
implementing, by the processor set, the data transformation only once, thereby generating the output; and
sharing, by the respective ML pipelines, the output with the ML pipelines during the group execution of the ML pipelines.

5. The method of claim 1, further comprising:
selecting, by the processor set, a subset of the ML pipelines based on the list of ranked ML models; and
performing, by the processor set, an execution of the subset of the ML pipelines using a second subset of the training data set as input data to the subset of the ML pipelines, thereby generating one or more updated ML models.

6. The method of claim 5, further comprising:
selecting, by the processor set, a highest ranking pipeline from the list of ranked ML pipelines, wherein the subset of the ML pipelines comprises the highest ranking pipeline.

7. The method of claim 6, further comprising:
performing, by the processor set, subsequent executions of the highest ranked pipeline, iteratively, using an additional subset of the training data set for each iteration, thereby generating an additional updated ML model for each of the subsequent executions of the highest ranked pipeline.

8. The method of claim 7, further comprising:
comparing, by the processor set, performance metrics of respective additional updated ML models to determine whether model accuracy has reached a saturation point based on a predetermined threshold.

9. The method of claim 8, further comprising:
ending, by the processor set, training of a latest one of the additional updated ML models based on determining that the model accuracy has reached the saturation point; and
presenting, by the processor set, a final trained ML model to a user based on the last one of the additional updated ML models.

10. The method of claim 1, wherein data of interest comprises multiple separate tables of data, and each of the tables of data is divided between the training data set and the validation data set.

11. A computer program product comprising one or more computer readable storage media having program instructions collectively stored on the one or more computer readable storage media, the program instructions executable to:
allocate multiple asset-centric multivariate time series data sets into a training data set and a validation data set based on predetermined rules;
perform a group execution of machine learning (ML) pipelines using a first subset of the training data set as input data for the ML pipelines, thereby generating a trained ML model for each of the ML pipelines, wherein data transformations that are common between the ML pipelines are implemented only once to generate an output, and the output is shared between the ML pipelines during the group execution of the ML pipelines;
generate performance metrics for each of the trained ML models based on the validation data;
rank the trained ML models based on the performance metrics, thereby generating a list of ranked ML models; and
output the list of ranked ML models to a user.

12. The computer program product of claim 11, wherein each of the ML pipelines includes a unique combination of one or more data transformers and an estimator.

13. The computer program product of claim 11, wherein the program instructions are further executable to:
determine that the data transformations are common between the ML pipelines;
implement the data transformations only once, thereby generating the output; and
share the output with the ML pipelines during the group execution of the ML pipelines.

14. The computer program product of claim 11, wherein the program instructions are further executable to:
select a highest ranking ML pipeline based on the list of ranked ML models; and
perform subsequent executions of the highest ranked pipeline, iteratively, using an additional subset of the training data set for each iteration, thereby generating an updated ML model for each of the subsequent executions of the highest ranked pipeline.

15. The computer program product of claim 14, wherein the program instructions are further executable to:
compare performance metrics of the respective updated ML models to determine whether model accuracy has reached a saturation point based on a predetermined threshold; and
end training of a latest one of the updated ML models based on determining that the model accuracy has reached the saturation point.

16. A system comprising:
a processor set, one or more computer readable storage media, and program instructions collectively stored on the one or more computer readable storage media, the program instructions executable to:
allocate multiple asset-centric multivariate time series data sets into a training data set and a validation data set based on predetermined rules;
perform a group execution of machine learning (ML) pipelines using a first subset of the training data set as input data for the ML pipelines, thereby generating a trained ML model for each of the ML pipelines, wherein data transformations that are common between the ML pipelines are implemented only once to generate an output, and the output is shared between the ML pipelines during the group execution of the ML pipelines;
generate performance metrics for each of the trained ML models based on the validation data;
rank the trained ML models based on the performance metrics, thereby generating a list of ranked ML models; and
output the list of ranked ML models to a user.

17. The system of claim 16, wherein the program instructions are further executable to dynamically generate the ML pipelines based on the data.

18. The system of claim 16, wherein the program instructions are further executable to:
determine that the data transformations are common between the ML pipelines;
implement the data transformations only once, thereby generating the output; and
share the output with the ML pipelines during the group execution of the ML pipelines.

19. The system of claim 16, wherein the program instructions are further executable to:
select a highest ranking ML pipeline based on the list of ranked ML models; and
perform subsequent executions of the highest ranked pipeline, iteratively, using an additional subset of the training data set for each iteration, thereby generating an updated ML model for each of the subsequent executions of the highest ranked pipeline.

20. The system of claim 19, wherein the program instructions are further executable to:
compare performance metrics of the respective updated ML models to determine whether model accuracy has reached a saturation point based on a predetermined threshold; and
end training of a latest one of the updated ML models based on determining that the model accuracy has reached the saturation point.
